(19) United States
(12) Patent Application Publication
(10) Pub. No.: US 2008/0098071 A1
(43) Pub. Date: Apr. 24, 2008

(54) METHOD AND PROCESS TO UNSUBSCRIBE FROM ON-GOING ELECTRONIC MESSAGE THREADS

(75) Inventors: Angela Richards Jones, Durham, NC (US); Tong Yu, Cary, NC (US)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/551,906

(22) Filed: Oct. 23, 2006

(51) Int. Cl. G06F 15/16

(52) U.S. Cl. 709/206

(57) ABSTRACT

A method, article, and system to implement software for enabling recipients to unsubscribe from an electronic message thread, in which case, the electronic message will not be delivered into the recipient's box, and therefore will not be utilizing any of the recipient's inbox space. The message server will hold the electronic message, where the recipient can access it if they choose. Also, other recipients who choose to reply-to-all will be notified of recipients who have unsubscribed, and will be able to then send the electronic message to the unsubscribed recipient if they are a required viewer.

### TRADEMARKS

IBM® is a registered trademark of International Business Maclines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to electronic mail messaging, and more particularly to providing a method, article, and system for enabling recipients to unsubscribe from an electronic message thread, with the subsequently undelivered messages addressed to the recipient held by a server for later access by the recipient, instead of within the recipient's message inbox. In addition, other recipients that choose to reply-to-all will be notified of recipients who have unsubscribed, and have the ability to override the recipient message settings if they need the recipient to receive the current message within the thread.

2. Description of the Related Art

Electronic messages such as email have become a central feature of modern life and users have come to expect to receive electronic mail messages at any time and in virtually any place. For example, during the course of one day of travel, a user may receive electronic mail messages at a home desktop computer in the early morning, an office desktop computer in midmorning, via a cell phone or personal digital assistant in a taxi on the way to the airport, on a laptop computer via a wireless local area network while waiting in the airport lounge, via an in-flight telephone on the airplane, and in a hotel room via a high-speed Internet connection provided by the hotel at the end of the day.

However, the widespread proliferation and availability of electronic messaging has also left the user with a feeling of being overwhelmed by the share volume of messages received in the course of the day. In addition the ease of use and minimal cost of distribution has led to mass email to large distribution lists. Users can find themselves receiving emails with topics they do not have an interest in reading. In another instance an email can be addressed to primary participants (required viewers), and at the same time to a separate group of individuals for informational purposes only (optional viewers). A potential problem arises when some of the recipients are not interested in the topic of the email thread, or when the thread evolves into a conversation that is no longer relevant to one or more recipients.

Email threads can go on for days, filling up a recipient's box with email that they are not interested in. A known solution is Microsoft Outlooks “Thread Killer”, which basically filters any incoming messages on this thread and puts the email into a folder. The “Thread Killer” solution also “reads” through the email, and if the receiver's name is mentioned, then this email will not be put in the thread folder. The problem with Outlook's solution is that the thread is still being delivered to the user's inbox, and using up space with a topic that the receiver has no interest in. In addition, keyword searching for the name is not always effective, since a person can have multiple aliases used by different people to describe the same individual (i.e. an email application may list a user as Angela, but she may be known as Angie to her co-workers, and Annie or Ann to her family, and in this instance the user does not receive all the parts of a thread meant for her, unless all of her aliases are available to the program).

The present invention is directed to addressing, or at least reducing, the effects of, one or more of the problems set forth above, by providing a method, article, and system for enabling recipients to unsubscribe from an email thread, in which case, the email will not be delivered into the recipient's box, and therefore will not be utilizing any of the recipient's inbox space. The email server will hold the email, where the recipient can access it if they choose. Also, other recipients who choose to reply-to-all will be notified of recipients who have unsubscribed, and will be able to then send the email to the unsubscribed recipient if they are a required viewer.

### SUMMARY OF THE INVENTION

Embodiments of the present invention comprise a method for enabling recipients to unsubscribe from an electronic message thread. The method comprises a program for managing electronic message threads employed with user interfaces, and one or more servers. An originating sender initiates an electronic message thread to one or more recipients, and one or more recipients can elect to unsubscribe from the electronic message thread utilizing the program via the user interface. The program of the present invention stores all undelivered messages from the electronic message thread addressed to a recipient who chooses to unsubscribe from the electronic message thread in a message server instead of in the unsubscribed recipient's message inbox. The electronic message thread comprises a series of messages and replies between the originating sender and recipients, as well as between the recipients themselves; and the messages have similar subject matter and/or a common address list.

The unsubscribed recipient is notified by the program of the present invention with an indicator on the user interface that an undelivered message from the electronic message thread is being held on a message server, and the undelivered message is available for review by the unsubscribed recipient if they request it. The indicator comprises at least one of the following: graphics, text, or audio. The program of the present invention notifies the message servers of the recipients when one or more recipients unsubscribe from the electronic message thread. The recipient message server only notifies the recipient of the unsubscribed recipient's status if the recipient attempts to send a new message in the electronic message thread to the unsubscribed recipient.

Employing the method of the present invention, the recipient can override the unsubscribed recipient's status, and send new message in the electronic message thread directly to the unsubscribed recipient's message inbox. Alternatively, the recipient can override the unsubscribed recipient's status; and the new message in the electronic message thread is held in said unsubscribed recipient's message server. The unsubscribed recipient is notified by the program by an indicator on the user interface that there are new messages from the electronic message thread being held on the message server; and that the new messages are available for review by the unsubscribed recipient if they request them. In another instance of the present invention, the recipient can override the unsubscribe recipient's status, and the unsubscribed recipient has the option to accept or reject said override. If the unsubscribed recipient accepts the override, the new message will be sent to the unsubscribed recipient's inbox. If the unsubscribed recipient rejects the override, the new message will be sent to the unsubscribed recipient's message server, with the new messages that are available for review by the unsubscribed recipient if they request them.

A system for implementing the method of the present invention, as well as, an article comprising one or more machine-readable storage media containing instructions that when executed enable a processor to carry out the method, are also provided.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIGS. 1A-1D are a series of diagrams illustrating the progression of an electronic message with multiple recipients according to an embodiment of the present invention.

FIG. 2 illustrates a system for practicing one or more embodiments of the present invention.

The detailed description explains the preferred embodiments of the invention, together with advantages and features, by way of example with reference to the drawings.

### DETAILED DESCRIPTION OF SPECIFIC EMBODIMENTS

Embodiments of the present invention provide a method and system for enabling recipients to unsubscribe from an email thread, in which case, the email will not be delivered into the recipient's box, and therefore will not be utilizing any of the recipient's inbox space. The email server will hold the email, where the recipient can access it if they choose. Also, other recipients who choose to reply-to-all will be notified of recipients who have unsubscribed, and will be able to then send the email to the unsubscribed recipient if they are a required viewer.

With the present invention when a recipient unsubscribes from an on-going email thread that is not of interest, the recipient's email server continues to monitor for any incoming mail on the thread (attributes are the email subject and the email parties) and holds the email. The recipient is presented with optional graphical, textual, and/or audio indicators informing them that there is email on this thread being held and is available for delivery for their review. In addition, when a recipient unsubscribes from an email thread, an indication is sent to the servers of the other parties of the email thread. The indication is not presented to the other parties unless they attempt to reply to this thread and include an unsubscribed recipient. When a replier is informed of the unsubscribed recipient, they can choose to override the un-subscription if they feel that the unsubscribed panty is flow a required reviewer of this pair of the email thread. If the current replier/sender chooses to override the un-subscription, the override is only good for this one email in the thread, and the un-subscription will still be in place for the remainder of the thread.

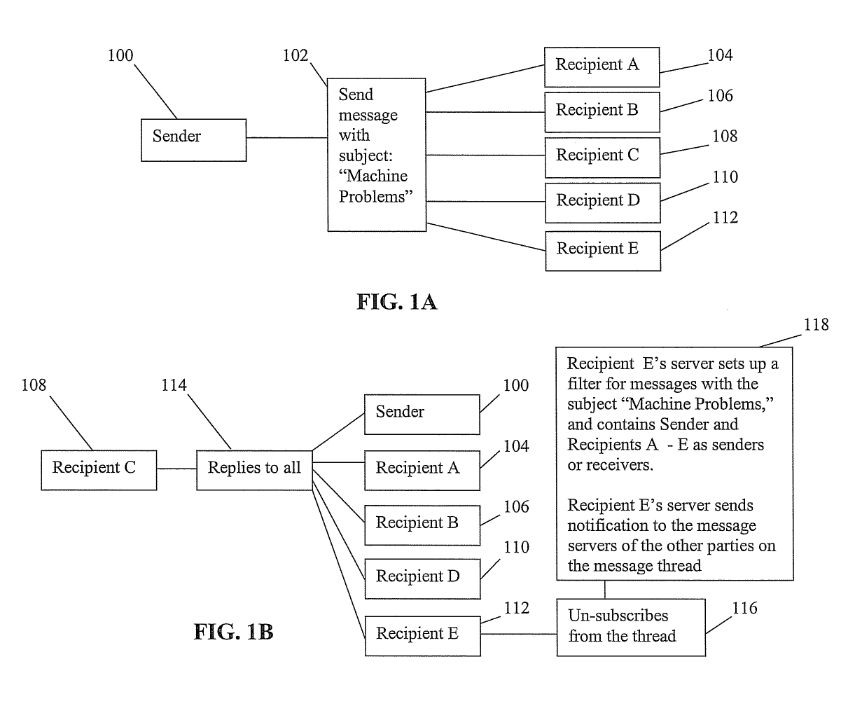

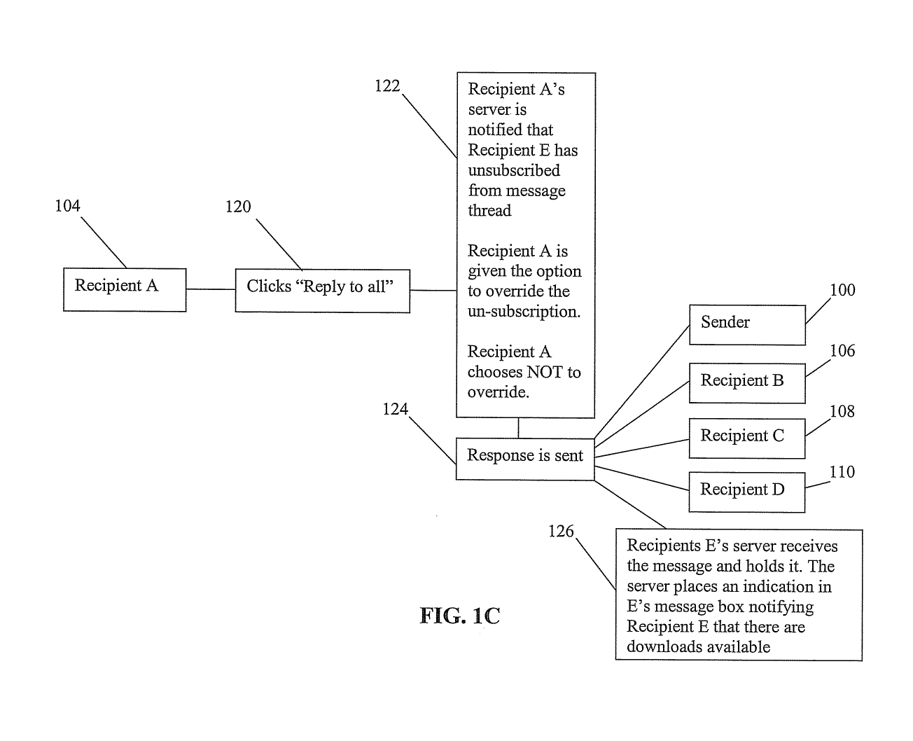

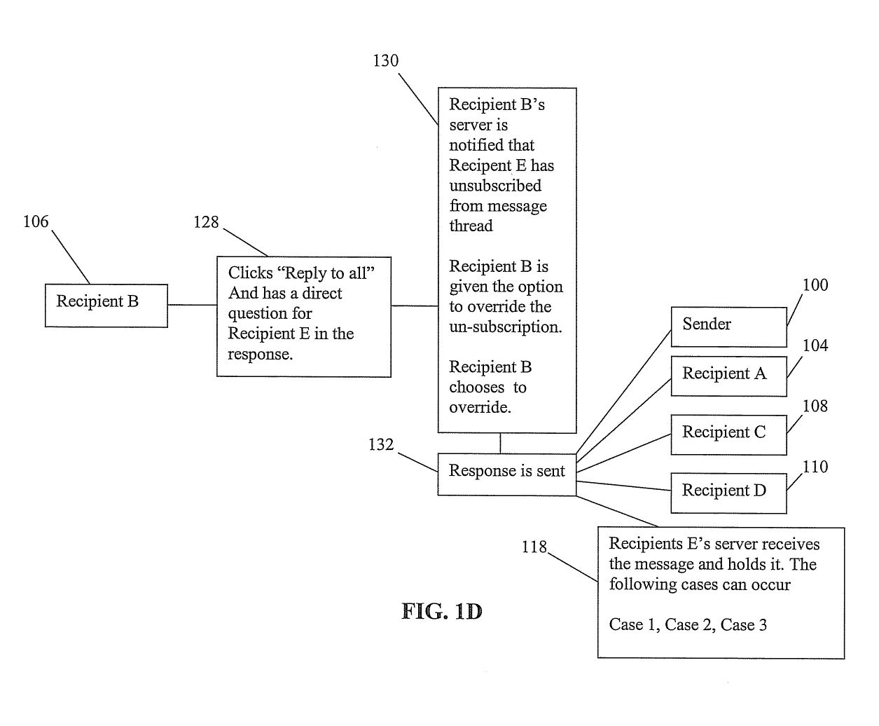

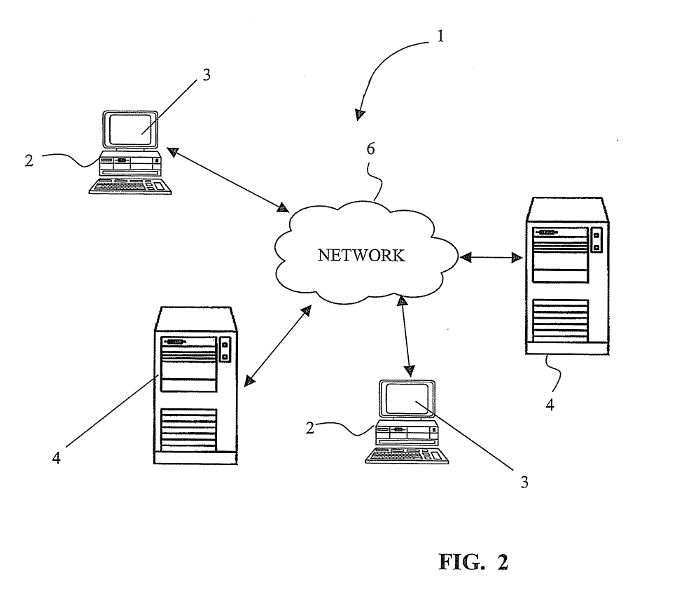

FIGS. 1A-1D illustrates the progression of an electronic message with multiple recipients according to an embodiment of the present invention. In FIG. 1A a sender 100 sends a message 102 with a subject of “Machine Problems” to five recipients (A, B, C, D, E) 104, 106, 108, 110, 112. Subsequently, in FIG. 1B recipient E 112 unsubscribes from the thread 116 with the “Machine Problem” subject matter. In response to recipient E 112, the server handling recipient E's messages 118 will filter for messages with the “Machine Problem” subject matter, as well as sender 100 and recipients 104, 106, 108, 110, and 112. In addition, recipient E's server 118 sends notification to the message servers of the other parties on the message thread of the unsubscribed status of recipient E 112. Recipient C 108 will receive the unsubscribed status of recipient E 112 since recipient C 108 sent a reply to all message 114 to all the original parties of the “Machine Problem” thread 102.

In FIG. 1C recipient A 104 sends a reply to all 120, and in response recipient A 104 is notified by recipient A's server 122 that recipient E 112 has unsubscribed from the message thread. Recipient A 104 is given the option to override recipient E's un-subscription, but in this case chooses not to override. Recipient A's response 124 is sent to the original sender 100, as well as recipients B, C, and D (106, 108, 110). However, with regards to recipient E 112 the message sent by recipient A 104 is held in recipient E's message server 118 that places a notification in E's message box that there are downloads available.

In FIG. 1D recipient B 106 sends a reply to all 128 with a specific question for recipient E 112, and in response recipient B 106 is notified by recipient B's server 130 that recipient E 112 has unsubscribed from the message thread. Recipient B 106 is given the option to override recipient E's un-subscription, and in this case chooses to override it. Recipient B's response 132 is sent to the original sender 100, as well as recipients A, C, and D (104, 108, 110). However, with regards to recipient E 112 the message sent by recipient B 106 is handled in one of three ways. In case 1, the message from recipient B 106 is sent by recipient E's message server 118 directly to recipient E's inbox as if they never unsubscribed from the message thread. In case 2, the message sent by recipient B 106 is held in recipient E's message server 118, which places a notification in E's message box that recipient B 106 has requested that their particular message be read by recipient E 112. In case 3, recipient E's message server 118 informs recipient E 112 that recipient B 106 has requested to override the un-subscription, and provides recipient E 112 with the option to accept or reject the override. If recipient E 112 rejects recipient B's override, the response message 128 is held in recipient E's message server 118, and recipient B 106 will be informed that recipient E 112 rejected their request to override. If recipient E 112 accepts recipient B's override, the message sent by recipient B 106 is delivered to the recipient E's inbox.

FIG. 2 is a block diagram of an exemplary system for implementing the message management of the present invention and graphically illustrates how those blocks interact in operation. The system includes one or more computing/communication devices 2 coupled to one or more servers 4 via a network 6. Each computing/communication device 2 may be implemented using a general-purpose computer executing a computer program for carrying out the processes described herein. The computing/communication devices 2 may also be, but are not limited to, portable computing devices, wireless devices, personal digital assistants (PDA), cellular devices, etc. The computer program may be resident on a storage medium local to the computing/communication devices 2, or maybe stored on the server system 4. The server system 4 may belong to a public service provider, or to an individual business entity or private party. The network 6 may be any type of known network including a local area network (LAN), wide area network (WAN), global network (e.g., Internet), intranet, wireless or cellular network, etc. The computing/communication devices 2 may be coupled to the server system 4 through multiple networks (e.g., intranet and Internet) so that not all computing/communication devices 2 are coupled to the server system 4 via the same network. In a preferred embodiment, the network 6 is a LAN and each computing/communication device 2 executes a user interface application (e.g., web browser) to contact the server system 4 through the network 6. Alternatively, a computing/communication device 2 may be implemented using a device programmed primarily for accessing network 6 such as a remote client. A display means 3 is provided for the user to interact with the message management program.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for enabling recipients to unsubscribe from an electronic message thread utilizing a program, wherein the method comprises:
sending an initial electronic message by an originating sender via a user interface to begin an electronic message thread to one or more recipients; and
unsubscribing from the electronic message thread by one or more recipients having the option to elect to unsubscribe from the electronic message thread utilizing their respective user interface; and
in response to the unsubscribing, the program storing all undelivered electronic messages from the electronic message thread addressed to the one or more recipients who chooses to unsubscribe from the electronic message thread in a message server instead of in the unsubscribed recipient's message inbox.

2. The method of claim 1, wherein:
the sending an initial electronic message thread comprises sending a series of messages and replies between the originating sender and the one or more recipients, as well as between the one or more recipients themselves; and
wherein the electronic messages have similar subject matter.

3. The method of claim 1, wherein:
the sending an initial electronic message thread comprises sending a series of messages and replies between the originating sender and the one or more recipients, as well as between the one or more recipients themselves; and
wherein the electronic messages have common address lists.

4. The method of claim 1, wherein:
the unsubscribing further comprises notifying via an indicator on a user interface of the one or more recipients in response to the unsubscribing by the one or more recipients to an electronic message thread that undelivered electronic messages from the electronic message thread are being held on a message server;
wherein the undelivered electronic messages are available for reviewing by the one or more recipients who have unsubscribed from the electronic message thread if they request them.

5. The method of claim 4, wherein:
the notifying employs an indicator comprising at least one of the following: graphics; text; and audio.

6. The method of claim 1, wherein:
in response to the unsubscribing, notifying the message servers of the one or more recipients and the originating sender that at least one of the one or more recipients have unsubscribed from the electronic message thread.

7. The method of claim 6, wherein:
the message servers of the one or more recipients and the originating sender notifies the one or more recipients and the originating sender of the unsubscribed recipients status in response to the one or more recipients or the originating sender attempting to send a new electronic message in the electronic message thread to the one or more unsubscribed recipients.

8. The method of claim 7, wherein:
in response to the unsubscribed status notification, the one or more recipients and the originating sender can override the unsubscribed recipients status; and
by overriding the unsubscribed recipient status, the one or more recipients and the originating sender can send a new electronic message in the electronic message thread directly to the one or more unsubscribed recipients' message inboxes.

9. The method of claim 7, wherein:
in response to the unsubscribed status notification, the one or more recipients and the originating sender can override the unsubscribed recipients status; and
by overriding the unsubscribed recipient status, the one or more recipients and the originating sender can send a new electronic message in the electronic message thread that is held in the one or more unsubscribed recipients' message servers; and
in response to the new message, the unsubscribed recipient is notified by an indicator on the unsubscribed recipient's user interface that one or more new messages from the electronic message thread are being held on the message server; and
the new messages being held on the message server are available for review by the unsubscribed recipient if they request them.

10. The method of claim 7 wherein;
in response to the unsubscribed status notification, the one or more recipients and the originating sender can override the unsubscribed recipients status;
in response to the override the unsubscribed recipient has the option to accept or reject the override; and
if the unsubscribed recipient accepts the override the new message will be sent to the unsubscribed recipient's inbox.

11. The method of claim 7 wherein;
in response to the unsubscribed status notification, the one or more recipients and the originating sender can override the unsubscribed recipients status;
in response to the override the unsubscribed recipient has the option to accept or reject the override;
if the unsubscribed recipient rejects the override the new message will be sent to the unsubscribed recipient's message server; and
the new messages are available for review by the unsubscribed recipient if they request them.

12. An article comprising machine-readable storage media containing instructions that when executed by a processor enable the processor to manage electronic message threads in a system, wherein the system comprises computer servers, mainframe computers, and user interfaces, and wherein the computer servers and mainframe computers serve as message servers, and wherein the user interfaces further comprise: desktop computers, laptop computers, mobile computing devices, and mobile communication devices and, the instructions for facilitating:
in response to an originating sender initiating an electronic message thread to one or more recipients;
wherein the one or more recipients or the originating sender can elect to unsubscribe from the electronic message thread utilizing the instructions via the user interfaces; and
wherein the instructions act to store all undelivered messages from the electronic message thread addressed to the one or more recipients or the originating sender who chooses to unsubscribe from the electronic message thread in a message server instead of in the unsubscribed recipient's message inbox.

13. The article of claim 12 wherein the initial electronic message thread comprises a series of messages and replies between the originating sender and the one or more recipients, as well as between the one or more recipients themselves; and
wherein the electronic messages have similar subject matter.

14. The article of claim 12 wherein the electronic message thread comprises a series of messages and replies between the originating sender and the one or more recipients, as well as between the one or more recipients themselves; and
wherein the electronic messages have a common address list.

15. The article of claim 12 wherein the instructions notify the unsubscribed recipient, with an indicator on the unsubscribed recipient's user interface, in response to an undelivered electronic message from the electronic message thread being held on the message server; and
wherein the undelivered messages are available for review by the unsubscribed recipient if they request them.

16. The article of claim 12 wherein the instruction notifies the message servers of the one or more recipients and the originating sender in response to at least one of the one or more recipients unsubscribing from the electronic message thread.

17. The article of claim 12 wherein the instructions control the message server to notify the one or more recipients or the originating sender of the unsubscribed recipients status in response to the one or more recipients or originating sender attempting to send a new electronic message in the electronic message thread to one or more unsubscribed recipients.

18. The article of claim 12 wherein the instructions facilitate the one or more recipients and the originating sender to override the unsubscribed recipients status; and
by overriding the unsubscribed recipient status, the one or more recipients and the originating sender can send a new electronic message in the electronic message thread directly to the one or more unsubscribed recipient's message inboxes.

19. The article of claim 12 wherein the instructions facilitate the one or more recipients and the originating sender to override the unsubscribed recipients status; and
by overriding the unsubscribed recipient status, the one or more recipients and the originating sender can send a new electronic message in the electronic message thread that is held in the one or more unsubscribed recipient's message servers; and
in response to the new message, the unsubscribed recipient is notified by an indicator on the unsubscribed recipient's user interface that one or more new messages from the electronic message thread are being held on the message server; and
the new messages are available for review by the unsubscribed recipient if they request them.

20. A system for managing electronic message threads and enabling recipients to unsubscribe from a message thread,
wherein the system comprises computing devices and a network;
wherein the computing devices further comprise at least one of the following:
computer servers;
mainframe computers;
desktop computers; and
mobile computing devices; and
wherein at least one of the computing devices is configured to execute electronic software that manages the electronic message threads; and
wherein the electronic software is resident on a storage medium in signal communication with at least one of the computing devices; and
wherein at least one of the computing devices is in signal communication with said network; and
wherein the network further comprises at least one of the following:
local area network (LAN);
wide area network (WAN);
a global network;
the Internet;
a intranet;
wireless networks; and
cellular networks;
wherein based on a recipients unsubscribing from an electronic message thread, the electronic software stores all undelivered electronic messages from the electronic message thread, addressed to a recipient who chooses to unsubscribe from the electronic message thread, in the storage medium instead of in the unsubscribed recipient's message inbox; and
wherein the electronic software notifies the unsubscribed recipient that undelivered messages are being held in the storage medium; and
wherein additional members of the message thread are notified of the recipients who have unsubscribed from the electronic message thread; and
wherein the additional members can override the unsubscribed status of the unsubscribed recipient.
